(19) United States
(12) Patent Application Publication
(10) Pub. No.: US 2008/0135813 A1
(43) Pub. Date: Jun. 12, 2008

(54) Carbon nanotube composite and manufacturing method thereof

(76) Inventors: Kenji Kaneko, Fukuoka-shi (JP); Tomoharu Tokunaga, Fukuoka-shi (JP); Zenji Horita, Fukuoka-shi (JP)

Correspondence Address: JORDAN AND HAMBURG LLP, 122 EAST 42ND STREET, SUITE 4000, NEW YORK, NY, 10168, US

(21) Appl. No.: 11/732,355

(22) Filed: Apr. 3, 2007

(30) Foreign Application Priority Data
Dec. 7, 2006 (JP) 2006-331078

(51) Int. Cl. H01B 1/00; C09C 1/44

(52) U.S. Cl. 252/502; 264/117

(57) ABSTRACT

The present invention provides a manufacturing method of a carbon nanotube composite which manufactures the carbon nanotube composite by integrally bonding a mixed powdery body which is formed by mixing a metal powdery body and carbon nanotubes. A mixed powdery body is pressurized in the uniaxial direction using the first mold and the second mold, and a strain stress is applied to the pressurized mixed powdery body in a non-heated state which applies no heat to the mixed powdery body from outside. The strain stress may be a stress generated by a rotational strain which is imparted to the mixed powdery body by rotating at least one mold of the first mold and the second mold with respect to another mold.

### BACKGROUND OF THE INVENTION

1. Field of the Invention

The present invention relates to a carbon nanotube composite and a manufacturing method thereof, and more particularly to a composite of metal and carbon nanotubes and a manufacturing method thereof.

2. Description of the Related Art

Conventionally, carbon nanotubes have been known as a material which possesses properties such as low density, high tensile strength and high heat conductivity. The carbon nanotubes are formed by, for example, charging carbon powdery body in a thermal plasma generated by a high frequency induction coil, wherein carbon is evaporated and re-bonded thus synthesizing the carbon nanotubes (for example, see JP-A-07-061803).

Particularly, the carbon nanotubes are light and exhibit a high strength compared to metal such as iron or aluminum or alloy and hence, the carbon nanotubes are expected to be used as a light and high-strength structural material.

However, the carbon nanotubes exhibit poor formability or machinability and hence, it is difficult to form an available structural material using only the carbon nanotubes per se. Accordingly, the carbon nanotubes must be used in a composite form with metal which exhibits sufficient ductility.

Further, in forming a composite made of carbon nanotubes and metal, as a general method, carbon nanotubes and metal are formed into the composite by heating. However, when carbon nanotubes and metal are heated, bonding of carbon in carbon nanotubes and metal occurs first due to thermal energy thus forming carbonized metal and, along with the formation of the carbonized metal, the structure of carbon nanotubes is damaged thus giving rise to a drawback that the composite having desired properties cannot be obtained.

That is, in forming the composite of the carbon nanotubes and metal, it is necessary to perform such a composite forming operation in a non-heated state thus making the formation of the composite made of carbon nanotubes and metal further difficult.

### SUMMARY OF THE INVENTION

Inventors of the present invention, under such circumstances, have arrived at the present invention in the course of studies and development of a method forming a composite made of carbon nanotubes and metal without heating.

The present invention is directed to a manufacturing method of a carbon nanotube composite which manufactures a carbon nanotube composite by integrally bonding a mixed powdery body which is formed by mixing a metal powdery body and carbon nanotubes, wherein the manufacturing method includes the steps of pressurizing the mixed powdery body in the uniaxial direction using a first mold and a second mold, and applying a strain stress to the pressurized mixed powdery body in an non-heated state which applies no heat to the mixed powdery body from outside.

According to the present invention, by pressurizing the mixed powdery body which is formed by mixing the metal powdery body and the carbon nanotubes in the uniaxial direction using the first mold and the second mold and, at the same time, by applying the strain stress to the pressurized mixed powdery body in a non-heated state which applies no heat to the mixed powdery body from outside thus integrally bonding the mixed powdery body. It is possible to manufacture the integral carbon nanotube composite from the mixed powdery body.

Particularly, in the manufactured carbon nanotube composite, the strain stress is applied to the pressurized mixed powdery body in a non-heated state and hence, crystal grains of metal crystal can be effectively made fine thus enhancing a tensile strength and hardness of the carbon nanotube composite.

Further, the manufacturing method of a carbon nanotube composite of the present invention is also characterized by following points.

### (1) In the strain applying step, at least one mold of the first mold and the second mold is displaced from another mold in the direction orthogonal to the pressurizing axial direction.

### (2) In the strain applying step, at least one mold of the first mold and the second mold is rotated with respect to another mold about pressurizing axis.

(3) The strain applying step includes a normal rotating step which normally rotates at least one mold of the first mold and the second mold with respect to another mold about a pressurizing axis, and a reverse rotating step which reversely rotates at least one mold of the first mold and the second mold with respect to another mold about the pressurizing axis.

### (4) In the normal rotating step and/or the reverse rotating step, the position of a rotary axis in the normal rotation and/or the reverse rotation is displaced.

### (5) In the pressurizing step, a state in which the mixed powdery body is pressurized at a predetermined pressure or more is maintained for a predetermined time.

Further, the carbon nanotube composite of the present invention is an integrally bonded carbon nanotube composite which is formed by pressuring a mixed powdery body which is formed by mixing a metal powdery body and carbon nanotubes in the uniaxial direction and, at the same time, by applying a strain stress to the mixed powdery body in a state that no heat is applied to the mixed powdery body from outside.

Further, the present invention is also characterized in that a stress generated by rotational strain is used as the strain stress.

### BRIEF DESCRIPTION of THE DRAWINGS

FIG. 1 is a schematic view of a device for manufacturing a carbon nanotube composite of the present invention;

FIG. 2 is a schematic view of a device for manufacturing a carbon nanotube composite of the present invention;

FIG. 3 is a schematic view of a device for manufacturing a carbon nanotube composite of the present invention;

FIG. 4 is a graph showing a measurement result of the Vickers hardness of the carbon nanotube composite according to an embodiment of the present invention; and

FIG. 5 is a graph showing a relationship between an addition quantity of carbon nanotubes and the Vickers hardness of the composite.

### DETAIL DESCRIPTION OF THE EMBODIMENT

A carbon nanotube composite and a manufacturing method thereof according to the present invention are a carbon nanotube composite which is formed by integrally bonding a mixed powdery body which is formed by mixing metal powdery body and carbon nanotubes and a manufacturing method thereof, wherein the mixed powdery body is bonded by pressurizing in the uniaxial direction using the first mold and the second mold and, at the same time, by applying a strain stress to the pressurized mixed powdery body in a non-heated state which applies no heat to the mixed powdery body from outside.

The metal powdery body is a powdery body formed out of particles having a particle size of approximately 100 μm or less, the carbon nanotubes are so-called single-layered carbon nanotubes, and the mixed powdery body is formed by sufficiently mixing the metal powdery body and the carbon nanotubes.

To be more specific, the mixed powdery body is formed such that a predetermined quantity of metal powdery body and a predetermined quantity of single-layered carbon nanotubes are uniformly charged into and dispersed in ethanol, an ultrasonic treatment is applied to the ethanol in air at a room temperature to dry the ethanol thus forming the mixed powdery body in which the metal powdery body and the single-layered carbon nanotubes are homogeneously dispersed.

The carbon nanotubes are not limited to the single-layered carbon nanotubes and may be formed out of multi-layer carbon nanotubes.

In mixing the metal powdery body and the carbon nanotubes, it is desirable to mix 80 to 99.9% by weight of metal powdery body and 0.1 to 20% by weight of carbon nanotubes each other. When it is necessary to improve the hardness of the carbon nanotube composite, a mixing ratio of the carbon nanotubes into the metal powdery body may be increased. However, when a mixing quantity of the carbon nanotubes exceeds 20% by weight, the integration of the metal powdery body and the carbon nanotubes may become difficult. Accordingly, by adjusting an applying condition of a strain stress, the carbon nanotube composite containing a larger quantity of carbon nanotubes may be formed.

The mixed powdery body is pressurized in the vertical direction by sandwiching the mixed powdery body between an upper mold which constitutes the first mold and a lower mold which constitutes the second mold which are arranged vertically. Here, although the pressurizing axial direction is set vertically by arranging the molds vertically in view of the pressurizing direction of a pressurizing means, the pressurizing axial direction is not limited to the vertical direction and the mixed powdery body may be pressurized in the lateral direction or in the longitudinal direction by arranging the molds in the lateral direction of the mixed powdery body or in the longitudinal direction of the mixed powdery body.

A storing portion in which the mixed powdery body is stored is formed in at least one mold of the upper mold and the lower mold. The mixed powdery body in the storing portion is pressurized by the upper mold and the lower mold and, at the same time, a strain stress is applied to the mixed powdery body.

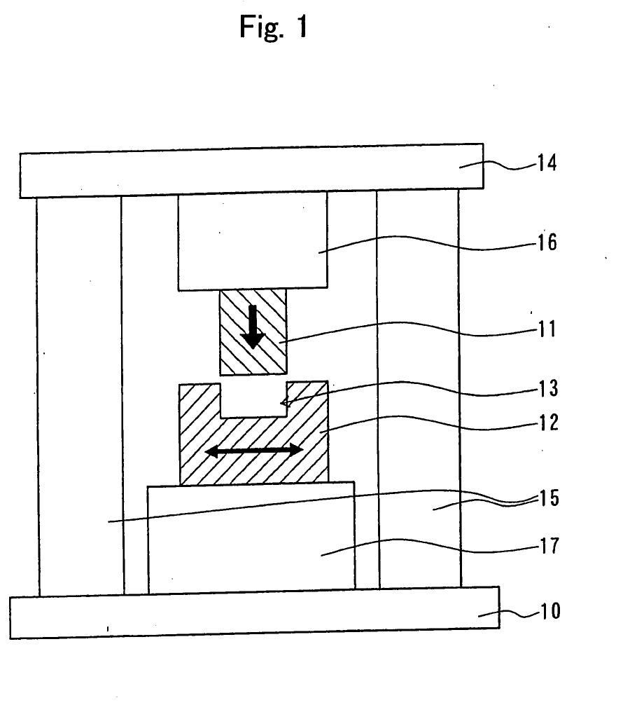

To be more specific, as schematically shown in FIG. 1, a storing cavity 13 is formed in an upper surface of the lower mold 12 by indentation in a recessed shape and, at the same time, the upper mold 11 is formed out of a rod which can be inserted into the storing cavity 13. The mixed powdery body which is stored in the storing cavity 13 is pressurized by pushing with the upper mold 11. Accordingly, the pressurizing axis direction is the vertical direction.

When heat is generated and temperature is elevated due to the applying of a strain stress to the mixed powdery body in the storing cavity 13 described later, it is desirable to provide a temperature control unit which suppresses the temperature elevation of the upper mold 11 and the lower mold 12. As the temperature control unit, a cooling fan for cooling air, a Peltier device or the like may be used. Here, the temperature elevation which takes place in the upper mold 11 and the lower mold 12 may be ignored when the temperature elevation does not exceed the recrystallization temperature of the metal powdery body. In the present invention, when the temperature of the mold does not exceed the crystallization temperature of the metal powdery body, the mold is deemed to be in a non-heated state.

In FIG. 1, numeral 10 indicates a base on which columns 15 supporting a ceiling portion 14 are mounted upright. On a predetermined portion of the ceiling portion 14 supported by the columns 15, an elevation control part 16 which lowers the upper mold 11 is mounted. By lowering the upper mold 11 by the elevation control part 16, the mixed powdery body in the inside of the storing cavity 13 is pressurized.

On a predetermined portion of the base 10, a drive part 17 is mounted and the drive part 17 applies the strain stress to the mixed powdery body which is pressurized in the storing cavity 13 by driving the lower mold 12 relative to the upper mold 11. The lower mold 12 is mounted on the drive part 17.

The drive part 17 displaces the lower mold 12 in the direction orthogonal to the pressurized direction by vibrating the lower mold 12 in the longitudinal direction, in the lateral direction, or in the longitudinal as well as in the lateral direction. Here, it is not always necessary for the drive part 17 to vibrate the lower mold 12 only in the planer direction orthogonal to the vertical direction, and it is sufficient that the vibrations contain vibration components in the longitudinal direction or in the lateral direction with respect to the vertical direction.

Amplitude of vibrations may preferably be approximately several times as large as a maximum particle size of the metal powdery body in the mixed powdery body at maximum and, in general, the amplitude vibrations may preferably be 100 μm.

Here, only the lower mold 12 is displaced in the orthogonal direction to the pressurizing axis direction by the drive part 17. However, the drive part may be mounted on the upper mold 11 side and the upper mold 11 may be displaced in the orthogonal direction to the pressurizing axis direction. In this case, an elevation control part may be mounted on the lower mold 12 and the lower mold 12 may be elevated to pressurize the mixed powdery body in the storing cavity 13. Alternatively, a drive part is mounted on both of the upper mold 11 and the lower mold 12 respectively, or the upper mold 11 and the lower mold 12 may be displaced in the respectively orthogonal directions to the pressurizing axis direction.

Alternatively, in place of vibrating the lower mold 12 the lower mold 12 may be rotated about the pressurizing axis relative to the upper mold 11 so as to apply the rotation strain to the mixed powdery body which is pressurized in the storing cavity 13.

When the lower mold 12 is rotated, it is possible to easily apply a larger strain than the strain which is applied by vibrating the lower mold 12.

Particularly, the drive part 17 is capable of performing the normal rotation which rotates the lower mold 12 in one direction and the reverse rotation which rotates the lower mold 12 in the reverse direction thus alternatively changing over the normal rotation and the reverse rotation.

Here, in place of rotating only the lower mold 12 about the pressurizing axis by the drive part 17, a drive part maybe mounted on the upper mold 11 side and the upper mold 11 may be rotated about the pressurizing axis.

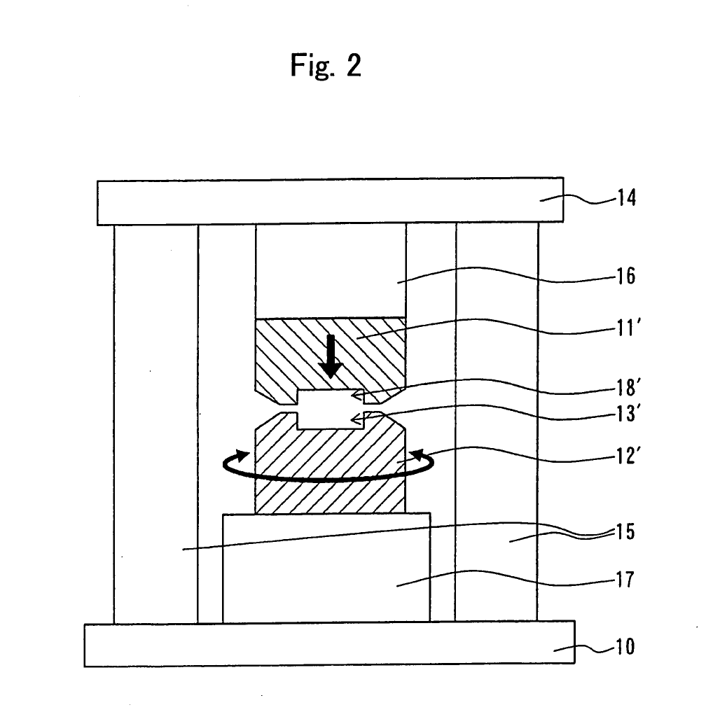

Further, in rotating the upper mold 11 and the lower mold 12 about the pressurizing axis, as shown in FIG. 2, a lower-side storing cavity 3′ which is indented in a recessed shape is formed in an upper surface of the lower mold 12′ and, at the same time, an upper-side storing cavity 18′ which is indented in a recessed shape is also formed in a lower surface of the upper mold 11′, and the lower-side storing cavity 13′ and the upper-side storing cavity 18′ may be arranged to abut each other.

In this case, the mixed powdery body which is stored in a storing portion formed of the lower-side storing cavity 13′ and the upper-side storing cavity 18′ is pressurized by the upper mold 11′ and the lower mold 12′ and, at the same time, a strain stress is applied to the mixed powdery body due to the rotation of the upper mold 11′ and/or the lower mold 12′ thus forming the carbon nanotube composite. Accordingly, depths of indentations of the lower-side storing cavity 13′ and the upper-side storing cavity 18′ can be decreased and hence, the formed carbon nanotube composite can be easily removed from the upper mold 11′ or the lower mold 12′.

Here, when the rotational strain is applied to the mixed powdery body which is pressurized by the upper mold 11, 11′ and the lower mold 12, 12′, the remoter from a rotational axis, the larger strain can be applied to the mixed powdery body. On the other hand, it is hardly possible to apply the rotational strain to the mixed powdery body in the vicinity of the rotational axis and hence, the formation of the carbon nanotube composite cannot be expected in the vicinity of the rotational axis.

Accordingly, when the upper mold 11, 11′ and/or the lower mold 12, 121 are/is rotated about the pressurizing axis, by rotating the upper mold 11, 11′ and the lower mold 12, 12′ while displacing the rotational axis, it is possible to prevent the formation of a region in the mixed powdery body to which a strain is not applied.

By vibrating the lower mold 12 or the upper mold 11 in the longitudinal direction or in the lateral direction, or in the longitudinal direction as well as in the lateral direction by the drive part 17 with respect to the vertical direction which is the pressurizing axis direction, the rotational axis can be relatively easily displaced

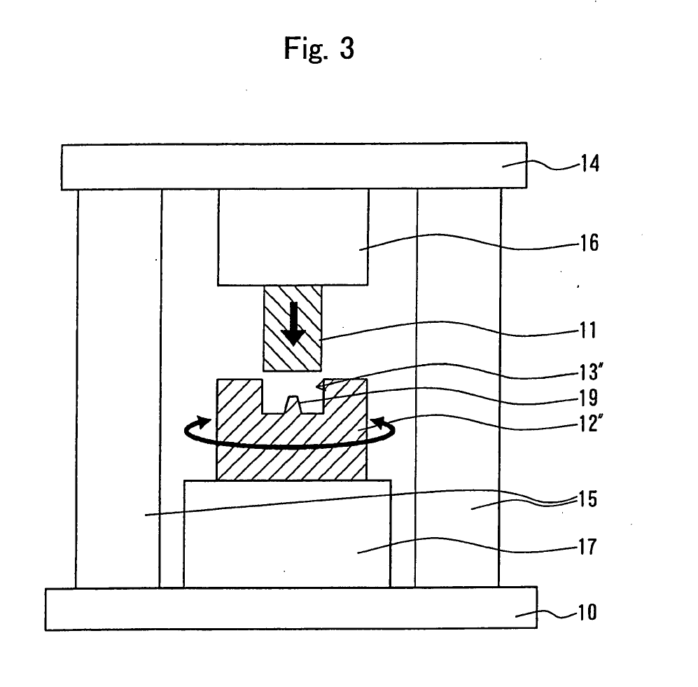

Alternatively, as shown in FIG. 3, a projection 19 is formed on the lower mold 12′ which includes the storing cavity 13′ in the vicinity of the pressurizing axis which constitutes the center of rotation. With the provision of the projection 19, a volume of the region in which the formation of the carbon nanotube composite cannot be expected may be reduced thus enhancing a manufacturing efficiency of the carbon nanotube composite.

### Embodiment

Hereinafter, an embodiment of the present invention is explained. In the embodiment, an aluminum powdery body of 99.99% purity having a diameter of 75 μm is used as the metal powdery body. 0.3 g of aluminum powdery body and 0.015 g of single-layered carbon nanotube are charged into and dispersed in 20 cc of ethanol, and the ultrasonic treatment is applied to ethanol for 300 seconds using an ultrasonic device (US-1) manufactured by Iuchi. Thereafter, ethanol is vaporized in air at a room temperature thus producing the mixed powdery body.

The mixed powdery body is pressurized by the device shown in FIG. 2 and, at the same time, the rotational strain is applied to the mixed powdery body by the device thus forming the carbon nanotube composite having a diameter of 10 mm and a thickness of 1 mm. Here, the pressure applied to the mixed powdery body is 2.5 GPa, and the lower mold 12′ is rotated 30 turns at a speed of 1 rpm by the drive part 17.

Here, the rotation of the lower mold 12′ is started when predetermined time elapses after pressurizing the mixed powdery body to a predetermined pressure or more by the upper mold 11′ and the lower mold 12′.

By pressurizing the mixed powdery body for the predetermined time or more at the predetermined pressure or more in the above-mentioned manner, gases which remain in the mixed powdery body can be discharged thus preventing the generation of pores in the carbon nanotube composite.

In this embodiment, the rotation of the lower mold 12′ is started after pressurizing the mixed powdery body for 5 seconds or more at a pressure of 2.5 GPa.

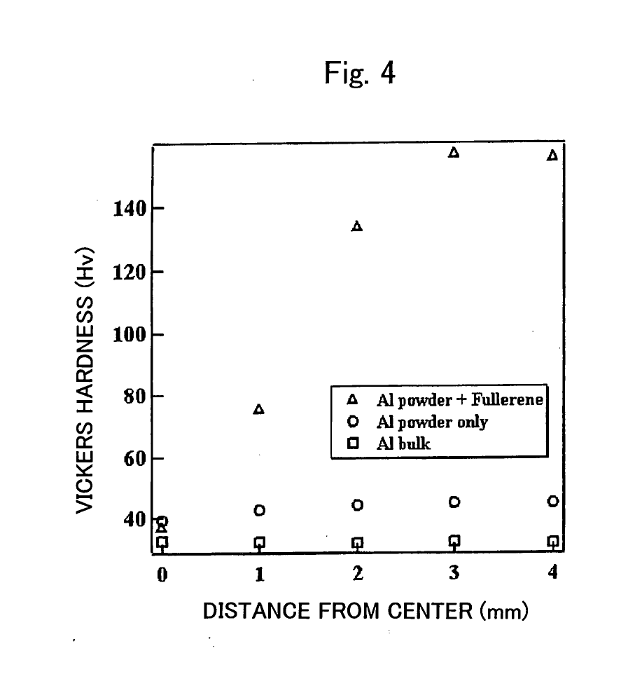

Vickers hardness of a disc-shaped carbon nanotube composite formed in the above-mentioned manner is measured at a position of a predetermined distance away from the center of rotation of the carbon nanotube composite. A result of measurement is shown in FIG. 4. As comparison examples, bulk aluminum and aluminum which is formed by pressurizing and applying a rotational strain to 100% by weight of aluminum powder to which no single-layered carbon nanotube (hereinafter, referred to as “additive-free aluminum”) are prepared and Vickers hardness values of these materials are measured.

As can be clearly understood from the result of measurement, the crystals of aluminum are made fine by applying the rotational strain and hence, the hardness values of the carbon nanotube composite and the additive-free aluminum are increased more than the hardness value of the bulk aluminum to which the rotational strain is not applied.

Further, there is almost no difference in hardness between the carbon nanotube composite and the additive-free aluminum in the vicinity of the center of rotation to which the rotational strain is hardly applied, and the hardness of the additive-free aluminum is more or less higher than the hardness of the carbon nanotube composite. However, the hardness is remarkably increased along with increase of the rotational strain. That is, while the hardness of additive-free aluminum is approximately 45 Hv, the hardness of carbon nanotube composite is approximately 80 Hv which is substantially twice as high as the hardness of the additive-free aluminum.

In view of the fact that a crystal grain size of additive-free aluminum is approximately 500 nm and a crystal grain size of aluminum in the carbon nanotube composite is approximately 100 nm, it is considered that the difference in the hardness is influenced by the refining of the crystal.

It is considered that the crystal-grain refining of aluminum in the carbon nanotube composite is accelerated since the crystal-grain coarsening of aluminum is suppressed.

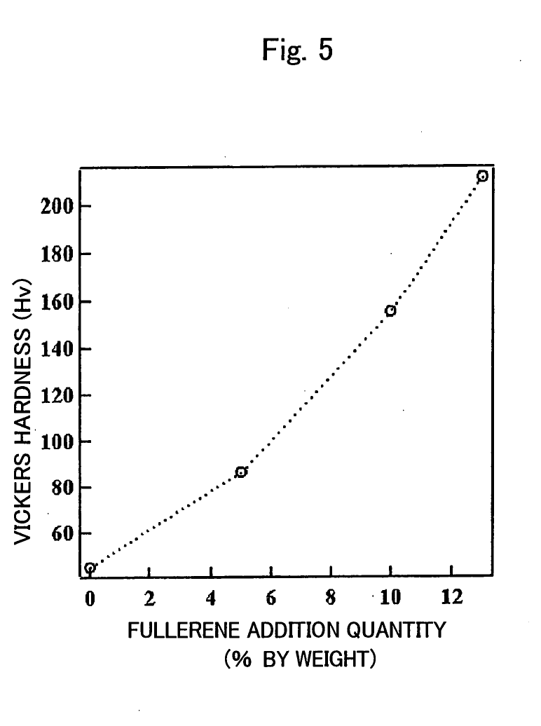

Particularly, as can be understood from FIG. 5 which shows the relationship between an addition quantity of carbon nanotubes and Vickers hardness, the hardness of the carbon nanotube composite can be increased by increasing the addition quantity of carbon nanotubes and hence, it is evident that the carbon nanotubes influence the crystal-grain refining of aluminum.

In this manner, in the carbon nanotube composite, the addition of carbon nanotubes can realize not only the formation of the composite made of the carbon nanotubes and metal but also the enhancement of hardness through the refining of crystal grains of metal thus enabling the production of a highly functional structural material.

Particularly, in the carbon nanotube composite, it is desirable to apply the large strain stress to the mixed powdery body as much as possible. For example, in applying the rotational stress to the mixed powdery body by rotating the lower mold 12′, by performing the normal rotation which rotates the lower mold 12′ in one direction but the reverse rotation which rotates the lower mold 12′ in the reverse direction at predetermined timing, it is possible to apply the further larger rotational strain to the mixed powdery body.

Particularly, when the lower mold 12′ is rotated not only in the normal direction but also in the reverse direction, in the vicinity of the rotational axis, it is possible to generate the strain larger than the strain generated when the lower mold 12′ is rotated only in the normal direction. Accordingly, the refining of the crystal grain can be accelerated also in the vicinity of the rotational axis and hence, the hardness in the vicinity of the rotational axis can be increased.

Here, when the lower mold 12′ is rotated in the reverse direction, it is not always necessary to rotate the lower mold 12′ at a rotational speed equal to a rotational speed of the normal rotation. For example, the lower mold 12′ may be reversely rotated one revolution for every several normal revolutions.

1. A manufacturing method of a carbon nanotube composite which manufactures the carbon nanotube composite by integrally bonding a mixed powdery body which is formed by mixing a metal powdery body and carbon nanotubes, the manufacturing method comprising the steps of:
pressurizing the mixed powdery body in the uniaxial direction using a first mold and a second mold; and
applying a strain stress to the pressurized mixed powdery body in a non-heated state which applies no heat to the mixed powdery body from outside.

2. A manufacturing method of the carbon nanotube composite according to claim 1, wherein the strain applying step allows at least one mold of the first mold and the second mold to displace from another mold in the direction orthogonal to a pressurizing axial direction.

3. A manufacturing method of the carbon nanotube composite according to claim 1, wherein the strain applying step allows at least one mold of the first mold and the second mold to rotate with respect to another mold about a pressurizing axis.

4. A manufacturing method of the carbon nanotube composite according to claim 3, wherein the strain applying step includes a normal rotating step which normally rotates at least one mold of the first mold and the second mold with respect to another mold about a pressurizing axis, and a reverse rotating step which reversely rotates at least one mold of the first mold and the second mold with respect to another mold about the pressurizing axis.

5. A manufacturing method of the carbon nanotube composite according to claim 4, wherein the position of the rotary axis in the normal rotation and/or the reverse rotation is displaced in the normal rotating step and/or the reverse rotating step.

6. A manufacturing method of the carbon nanotube composite according to one of claims 1 to claim 5, wherein a state in which the mixed powdery body is pressurized at predetermined pressure or more is maintained for a predetermined time in the pressurizing step.

7. A carbon nanotube composite which is manufactured by integrally bonding the mixed powdery body by pressurizing a mixed powdery body which is formed by mixing a metal powdery body and carbon nanotubes in the uniaxial direction and, at the same time, by applying a strain stress to the pressurized mixed powdery body in a non-heated state which applies no heat to the mixed powdery body from outside.

8. A carbon nanotube composite according to claim 7, wherein the stress generated by rotational strain is used as the strain stress.
